(19) United States
(12) Patent Application Publication
(10) Pub. No.: US 2006/0045091 A1
(43) Pub. Date: Mar. 2, 2006

(54) Transmission device

(75) Inventor: Akihiro Hata, Kawasaki (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/062,630

(22) Filed: Feb. 23, 2005

(30) Foreign Application Priority Data
Aug. 31, 2004 (JP) 2004-253578

(51) Int. Cl. H04L 12/56

(52) U.S. Cl. 370/392; 370/401

(57) ABSTRACT

A switching device provides a technique for detecting, in a switch equipped in a layer-2 network, frame forwarding loops in a network. The switching device comprises an interface part operable to input a frame, a switching part operable to switch in accordance with a destination address of the input frame, a comparing part operable to compare a switch identifier recorded in the input frame with its own switch identifier, and a notifying part operable to provide notification of a match when comparison results obtained by the comparing part match.

### CROSS REFERENCE TO RELATED APPLICATION

This application is related to and claims priority to Japanese Application No. 2004-253578 filed Aug. 31, 2004 in the Japanese Patent Office, the contents of which are incorporated by reference herein.

### BACKGROUND OF THE INVENTION

1. Field of the Invention

The present invention relates to a transmission device which performs frame forwarding, more specifically, a transmission device which performs frame forwarding loop detection with a frame forwarding switch (hereinafter also referred to as a “switch”) having a function which forwards ETHERNET® frames (hereinafter also referred to simply as “frames”) that are used in a local area network (LAN), metro area network (MAN), wide-area ETHERNET® network, wireless LAN, and the like.

2. Description of the Related Art

Bridge networks initially were mainly used in LANs, but in recent years their area of use has expanded to carrier networks, such that they have come to be referred to as “wide-area ETHERNET®s”.

Spanning Tree Protocol (hereinafter, “STP”) is a protocol for constructing a single spanning tree (loop-free tree) from a desired bridge LAN (local area network) topology, and is specified in standard IEEE 802.1 D (Media Access Control (MAC) Bridges). The functions of the STP have been expanded by the IEEE 802.1s (MSTP: Multiple Spanning Tree Protocol) and IEEE 802.1w (RSTP: Rapid Spanning Tree Protocol), and it has come to be widely used in bridge networks.

An ETHERNET® switch has the superior characteristic of automatically learning the MAC address and receiving port of the transmission source contained in an ETHERNET® frame received via a network and being able to perform switching automatically based on the information learned.

Nevertheless, when a network is connected in the form of a loop for some reason, the frame being transmitted may fall into that loop infinitely within that network. If this type of frame falls into a loop, the remainder of the communication is adversely affected.

Japanese Unexamined Patent Application Publication 2001-197114 describes a technique whereby frame information and receiving time are recorded in a table and the second receipt of the same frame is detected when frames are received as a technique for detecting a loop by analyzing the received frame without the presence of another device has been disclosed. In other words, an ID contained in the frame and indicating the transmission source IP address and packet transmission sequence is checked, and if the contents match, it is determined that a loop has occurred in frame transmission.

Nevertheless, a layer-2 frame forwarding loop detection technique that is no dependent upon a higher protocol (such as an IP) has been desired.

In particular, while the ETHERNET® switch has often been used in comparatively small-scale networks such as LANs, in recent years it has come to be used in MANs and wide-area ETHERNET® networks, making it possible to construct large-scale networks. In particular, carrier networks in which a high level of reliability is required have increased in scale, their topology has become more complex, and frame forwarding loop detection mechanisms have come to be considered more important.

When a large-scale network is configured using a transmission device (hereinafter also referred to as a “node device”) that forwards frames, topology loops are sometimes constructed due to factors such as human error. A feature of an ETHERNET® is that when a topology loop is created based on the design, a frame will tend to circulate infinitely through that loop and will propagate, so the construction of a loop can have a serious influence on the network.

The present intention has the objective of detecting the occurrence of loops which seriously affect communication by means of a simple configuration in networks which use a transmission device that performs frame forwarding.

### SUMMARY OF THE INVENTION

The switching device of the present invention, in order to achieve the aforementioned purpose, is provided with an interface part for inputting frames, a switching part for switching in accordance with the destination address of the input frame, a comparing part which compares a switch identifier recorded in said input frame with its own switch identifier, and a notifying part which provides notification of a match when the comparison results obtained by said comparing part match.

By means of this constitution, if the system's own switch identifier, which is unique in the network, is recorded in an input frame, it is possible to know when the same frame has returned. In other words, the occurrence of a frame forwarding loop within the network can be detected.

In addition, a switching device that is the switching device of this invention, is provided with a deciding part which decides whether a switch identifier is recorded in the aforesaid input frame.

By means of the deciding part, it is possible to determine whether the switch identifier recorded within the frame has been correctly recorded.

In addition, in the switching device of the present invention, the aforementioned deciding part determines whether the switch identifier has been recorded in an unused region within an input frame having a specified protocol. In other words, if a switch identifier has been recorded in an unused region in the input frame, it is possible for the deciding part to determine whether the switch identifier has been recorded in the aforesaid unused region.

In addition, in the switching device of the present invention, the aforementioned deciding part determines whether the switch identifier has been recorded in an unused region within an input frame as a specified protocol. In other words, if a switch identifier has been recorded in an unused region in the input frame, it is possible for the deciding part to determine whether the switch identifier has been recorded in the aforesaid unused region.

Moreover, in the switching device of the present invention, a loop occurrence location identifying part is additionally provided, and said loop occurrence location identifying part, based on notification from said notifying part, generates and transmits within the network an explorer frame for detecting the loop occurrence location in the network.

By means of the present invention, it is possible to detect the occurrence of frame forwarding loop generation by a frame transmission device within a network by means of a simple configuration.

### DESCRIPTION OF THE DRAWINGS

FIG. 1 is a diagram showing an example of the constitution of a switch according to the present invention.

FIG. 2 is a diagram showing an example of the frame forwarding loop detection flow in a switch according to the present invention.

FIG. 3 is a diagram showing an example of the format of an ARP frame.

FIG. 4 is a diagram showing the formats of a switch identifier and error detection code recorded in the padding part.

FIG. 5 is a diagram showing an example of embodiment in which the loop location of a frame in a network is searched.

FIG. 6 is a diagram showing the transmission flow of an explorer frame which investigates a loop occurrence location.

FIG. 7 is a diagram showing one example of an explorer frame.

FIG. 8 is a diagram explaining the process flow when an explorer frame is received.

FIG. 9 is a diagram showing one example of an explorer frame in which transit node switch identifiers have accumulated.

FIG. 10 is a diagram showing the process flow whereby loop occurrence locations within the network are specified.

FIG. 11 is a diagram showing an example of embodiment in which the loop location of a frame in a network is searched.

FIG. 12 is a diagram showing one example of an explorer frame.

FIG. 13 is a diagram explaining the process flow when an explorer frame is received.

FIG. 14 is a diagram showing the process flow whereby a loop occurrence location is specified in a network.

FIG. 15 is a diagram showing one format of a search port table.

### DETAILED DESCRIPTION OF THE PREFERRED EMBODIMENTS

Modes for implementing the present invention are next explained, with reference to the figures. In the figures, the same reference code indicates the same or a corresponding object.

<Detection of a Frame Forwarding Loop in a Network>

In Embodiment 1, an instance where the specified protocol for loop detection of frame forwarding is an ARP (Address Resolution Protocol) frame is discussed.

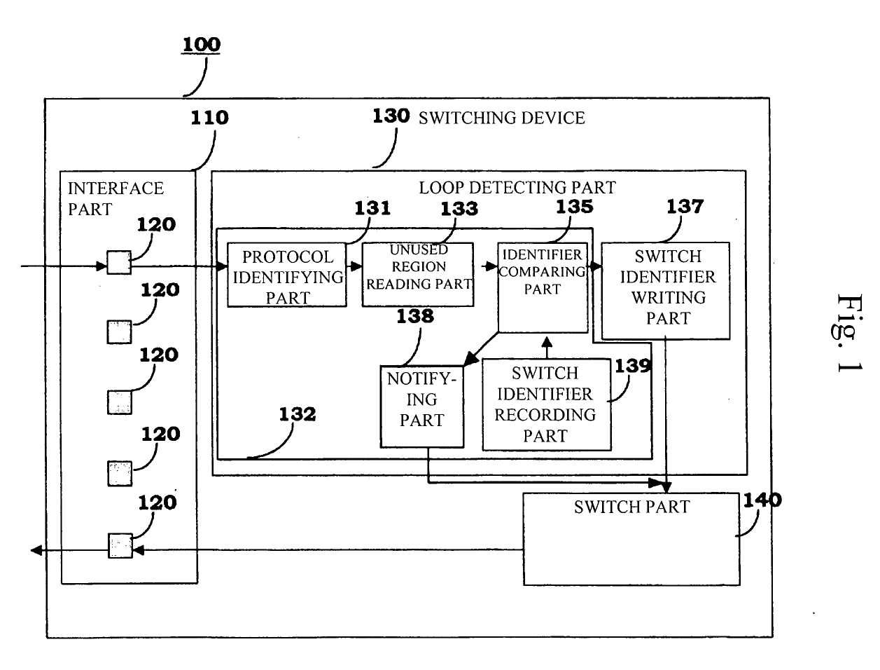

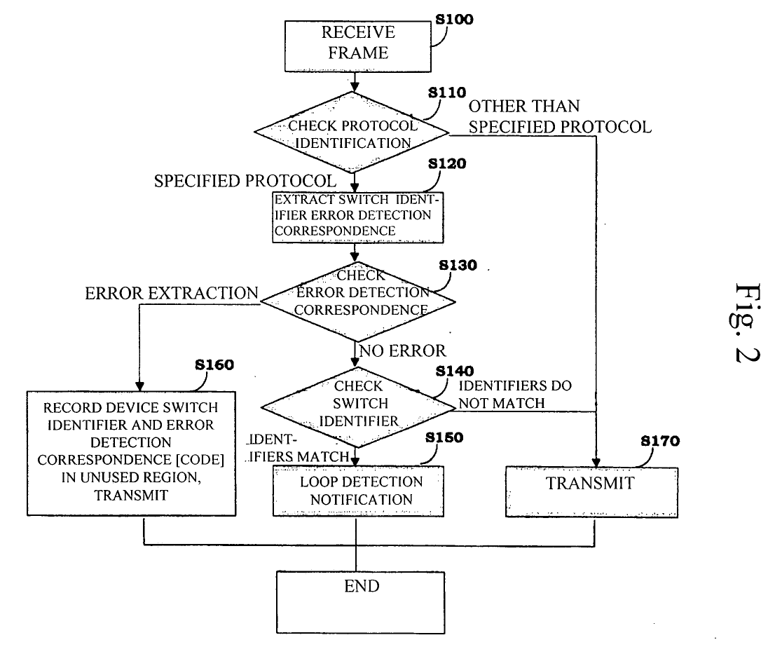

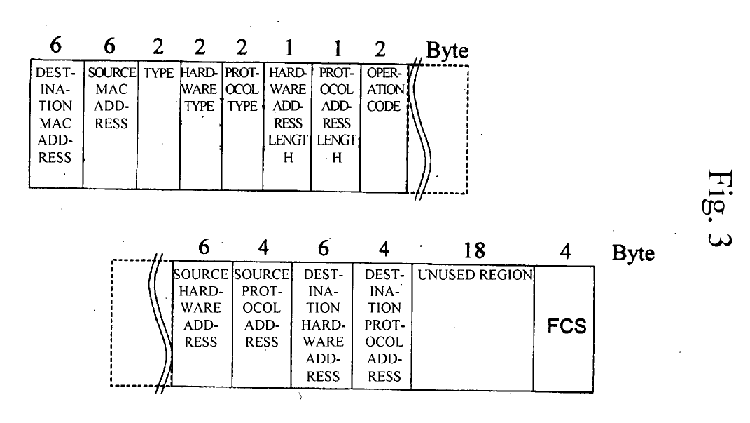

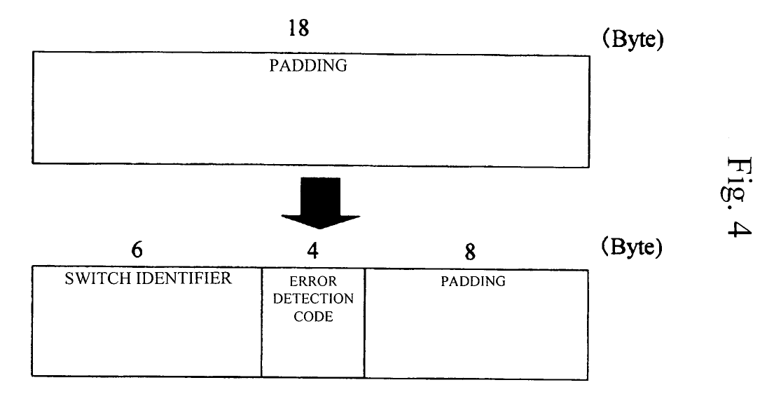

FIG. 1 is a diagram showing an example of the constitution of a switch according to the present invention. FIG. 2 is a diagram showing the loop detection flow in frame forwarding by the switch of the present invention. FIG. 3 is a diagram showing an example of the format of an ARP frame. FIG. 4 is a diagram showing an example of the format of a switch identifier and error detection code recorded in a padding part.

The switch configuration and an overview of its functions in an embodiment of this invention are explained, with reference to FIG. 1 and FIG. 4.

The principal parts of the switching device (hereinafter referred to as a transmission device or node device) of this embodiment comprise an interface part 110, a loop detection part 130 which detects during frame transmission whether or not a frame that has been input has looped within the network at least once, and a switch part 140 which selects a suitable interface 120 in accordance with the source MAC (Media Access Control) contained in the header of the frame that has been input.

The loop detection part 130 is composed of a deciding part 132 which decides whether a specified input frame has fallen into a loop state in the network and whether to perform frame forwarding, and a local switch identifier writing part 137, which writes its own switch identifier into that frame.

The deciding part 132 receives frames through the interface part 110 (FIG. 2, Step S100).

Next, a protocol identifying part 131 checks (determines) whether the received frame is a specified protocol (FIG. 2, Step S110).

In this embodiment, a switch which detects the looping of a frame using ARP frames having an ARP protocol as the specified protocol is realized.

An ARP protocol is a protocol for obtaining hardware addresses such as MAC addresses from an IP addresses. The format of this ARP frame is shown in FIG. 3. Please note the unused region (18 bytes) in the APP frame in the figure.

When the specified protocol that has been input is an APP protocol, for example, in IPv4, the ARP frame has an effective frame data length of 48 bytes, but since this is less than 64 bytes, the frame is forwarded after padding (unused region) of 18 bytes has been automatically added and the frame length has been adjusted to 64 bytes. Thus, if the unused region is usable, it can be used as a frame for the aforesaid specified protocol. Such a specified protocol having an unused region can also be used in IPv6.

Since a broadcast address is set in the destination address of this ARP frame, the ARP frame is received by all switches within the layer-2 network.

Specifically, the transmitted ARP frame is broadcast via switches, and this ARP frame is forwarded to all terminals via the switches in the layer-2 network.

In a switch which uses the present invention, the received frame is forwarded to a protocol identifying part 131 of the loop detection part 130 via an interface part 120. The protocol identifying part 131 determines whether or not the frame received is an ARP frame.

In other words, the protocol identifying part 131 reads the 2-byte type field from the 13th byte from the head of the frame, and if this is “0x0806” identifies the received frame as an APP frame. Here, frames identified as not being ARP frames are forwarded to a switch part 140, where forwarding is performed based on the destination and MAC address.

If it is determined that the received frame is an ARP frame, the unused region reading part 133 reads information from the aforesaid unused region of the ARP frame.

FIG. 4 shows an example of the format of the unused region in the ARP frame and the format in which the 6-byte switch identifier is read in this unused region.

In this example, the formats of the switch identifier and error detection code which are written into the unused region of the ARP frame are described. Here, a bridge ID or other unique identifier in the network can be used as the switch identifier. These are one example and identifiers are not limited to these. First, the unused region detecting part 133 unconditionally reads the switch identifier (6 bytes) and error detection check (4 bytes) from the unused region of the ARP frame (FIG. 2, S120), and then examines the switch identifier that has been read as to whether there is a code error in the switch identifier based on the error detection check (FIG. 2, Step S130). A CRC (cyclic redundancy check) is used as the error detection check. Other error detection checks may also be used.

If code error is not detected as a result of examination of the error code corresponding to the switch identifier, the identifier comparing part 135 compares the local switch identifier recorded in the switch identifier recording part 139 and the switch identifier extracted from the unused region of the ARP frame (FIG. 2, Step S140).

If these comparison results match, then it is concluded that the frame transmitted from the local switching device has returned to the local switching device by a means other than an ARP protocol, and that a loop has occurred in frame transmission on the network. The identifier comparing part 135 notifies the notification part 138 of the detection of this loop, and the notification part 138 notifies the terminals connected to the network via the switch part 140 (FIG. 2, Step S150). Alternatively, it may notify a network management station (NMS), or notify the operator by display on a console or the like.

When the switch identifier extracted from the unused region of the ARP frame and the local switch identifier are compared, if they do not match, the frame is forwarded to a network not shown via the switch part 140 and interface 120 (FIG. 2, Step S170).

In the examination of the aforesaid code error by the identifier comparing part 135, if a code error is detected, the switch identifier is processed as if it has not been recorded in the unused region (18 bytes) of this ARP frame.

In other words, when the aforesaid ARP frame is forwarded-by the switch, it does not pass through all of the switches in which the present invention is used. The ETHERNET® switch of the present invention records its own switch identifier in the unused region of the ARP frame (FIG. 2, Step S160). Next, forwarding to the network, not shown in the figures, is performed through the switch part 140 and interface 120.

<Identification of the Loop Location in the Network>

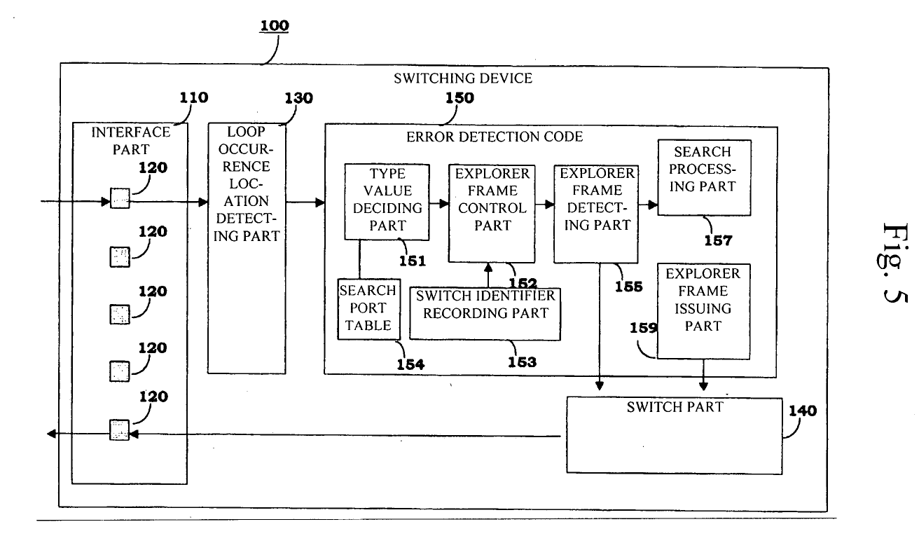

In Embodiment 2, an example of searching for a loop location in a network is explained, with reference to FIG. 5 through FIG. 10.

FIG. 5 is a diagram showing an example of embodiment in which the frame loop location is searched for in a network. The difference from FIG. 1 is in the fact that a loop occurrence location searching part 150 is now provided. Accordingly, this explanation will concentrate on the loop occurrence location searching part 150.

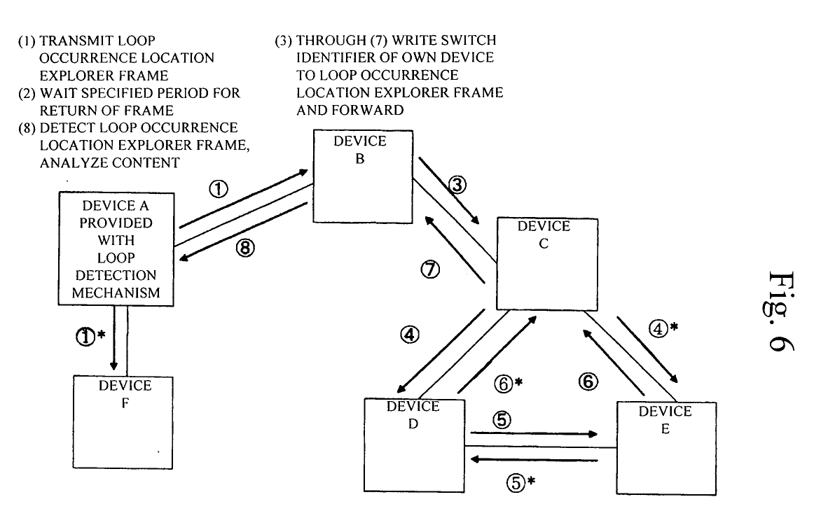

FIG. 6 is a diagram showing the constitution of the searching process for the loop location in a network by the loop occurrence location searching part 150 when the loop detecting part 130 has detected a loop in frame forwarding.

The loop occurrence location searching part 150 performs a search process for the location of a detected frame forwarding loop occurrence utilizing the receipt of the notification of the detection of a frame forwarding loop from the loop detecting part 130. In order to perform this process, the loop detecting part 130 subsequently forwards the received frame to the loop occurrence location searching part 150.

Next, the loop occurrence location searching part 150, after performing the loop occurrence location searching process for that frame, forwards the location to the switch part 140. The switch part 140 performs the switch process in accordance with the destination MAC address of that frame, and that frame is forwarded to the network via the appropriate interface 120.

The loop occurrence location searching part 150 is explained below in further detail.

The loop detecting part 130, which has detected a loop in frame forwarding in the network, notifies the explorer frame issuing part 159 of this detection.

The loop occurrence location searching part 150 shifts to a status in a mode waiting for the return of the loop location explorer frame, and the explorer frame issuing part 159 generates an explorer frame to obtain detailed information on the loop.

Next, the explorer frame issuing part 159 sends out the issued explorer frame to the network via the switch part 140 and interface part 110.

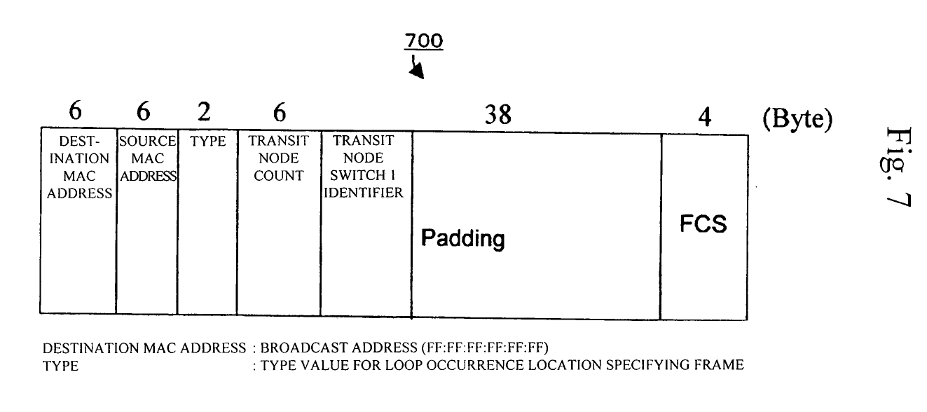

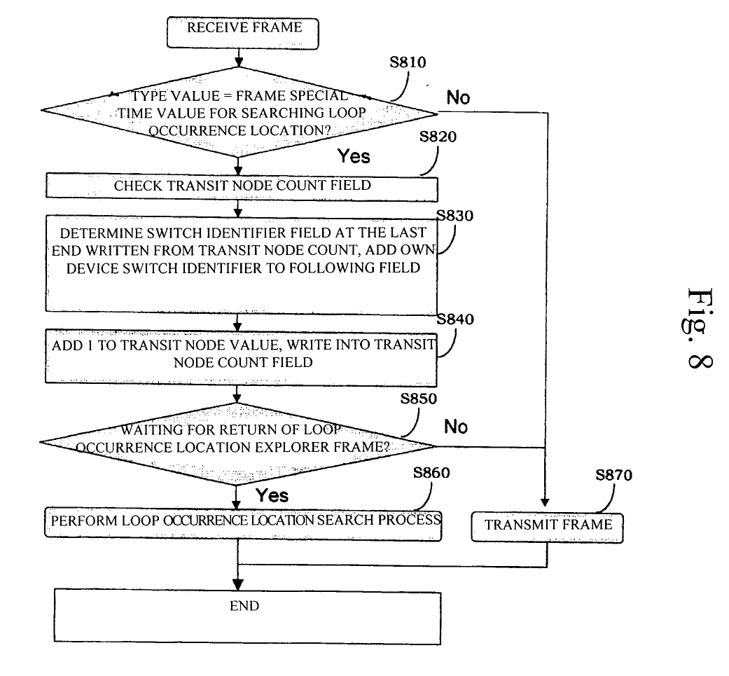

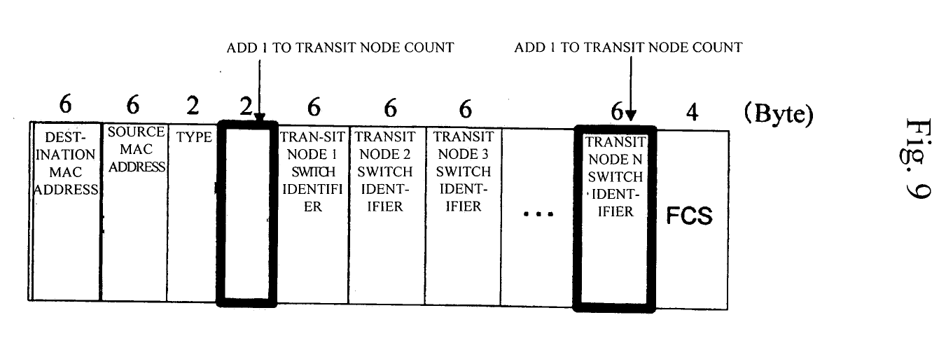

One example of an explorer frame is shown in FIG. 7, and FIG. 8 is a diagram explaining the process flow when an explorer frame is received. FIG. 9 is a diagram showing an example of an explorer frame that has accumulated switch identifiers for transit nodes. In the figure, the type value indicates that this is the explorer frame 700. Specifically, the present invention uses a value to represent the type of the explorer frame, which performs the process of searching for the location of the detected frame forwarding loop occurrence, which is an unused type value not designated by a standardized design (e.g., IEEE 802.1 d, etc.).

In FIG. 7, the number of transit nodes is increased by 1 each time an explorer frame 700 passes through a switch device 100 which uses the present invention. The initial value is set at 0 (zero), for example, when an explorer frame 700 is generated. If there is no limitation to the frame length, it is possible to show transit through 65,535 switch devices. This region is 2 bytes and can be expanded.

The switch identifier of at least one transit node is stored after the transit node count. When a plural number of identifiers is stored, additional storage is performed referring to the transit node count so as not to overwrite the transit node switch identifiers that have already been recorded. All binary “0” or all binary “1” can be used in the padding, but the padding may also be an inconstant value if the aforesaid transit node count is relied on. In other words, if all binary “0” or all binary “1” is used as the padding, the transit node count can be obtained by totaling that number.

The final FCS (Frame Check Sequence) is well-known art, and explanation thereof is therefore omitted.

The issued explorer frame 700 designates a broadcast (FF:FF:FF:FF:FF:FF for the destination MAC address) as the destination address, and is sent out to the network from its own switching device 100. Next, the switch identifier of the transit node is incrementally stored in the explorer frame 700 each time each time it passes through any of the switching devices 100 in which the present invention is applied.

Next, if detection of the loop status is continued, an explorer frame 700 in which the same switch identifier as that recorded by the local switching device is stored will be received. The details of the receiving process by the loop occurrence location searching part 150 of its own switching device 100 are explained below.

The frame sent from the loop detecting part 130 is forwarded to the type value determining part 151. The type value determining part 151 checks the type value of the frame and decides whether it is the explorer frame 700 (FIG. 8, Step S810). Frames which are not the explorer frame 700 are routed through the switch part 140 and interface 121 based on the destination MAC address of this frame and forwarded (FIG. 8, Step S870). If the frame is the explorer frame 700, it is transmitted to the explorer frame control part 152.

The explorer frame control part 152 reads and checks the transit node count in the explorer frame 700 (FIG. 8, Step S820). It then determines the position for additionally writing its own switch identifier. The switch identifier of the local switch device recorded in the switch identifier recording part 153 is read, and the local switch identifier is recorded in the position to be written in the aforesaid explorer frame 700 (FIG. 8, Step S830). The transit node is incremented by 1 (FIG. 8, Step S840).

It is determined whether the local switch device 100 is awaiting the return via a loop of the loop occurrence location explorer frame (FIG. 8, Step S850).

If it is in waiting status, the explorer frame 700 is detected by the explorer frame detecting part 155, additional writing of the local switch identifier into the explorer frame 700 is performed (FIG. 9, transit node n switch identifier), and the explorer frame 700 with node count incremented by 1 is forwarded to the search processing part 157. If it is not waiting, the explorer frame 700 is forwarded to the switch part 140, and transmitted to the network via the interface 120 (FIG. 8, Step S870).

By the switching device 100 adding its own switch identifier to the explorer frame, the frame length is extended. If the loop occurrence location explorer frame 700 exceeds the MTU (Maximum Transmission Units), it is discarded.

In the search processing part 157, when the loop occurrence location explorer frame 700 has returned due to the occurrence of a loop within the network, a loop occurrence location search process is performed based on information recorded in the loop occurrence location explorer frame 700 (FIG. 8, Step S860).

FIG. 6 is a diagram showing the forwarding flow of the explorer frame that investigates the loop occurrence location.

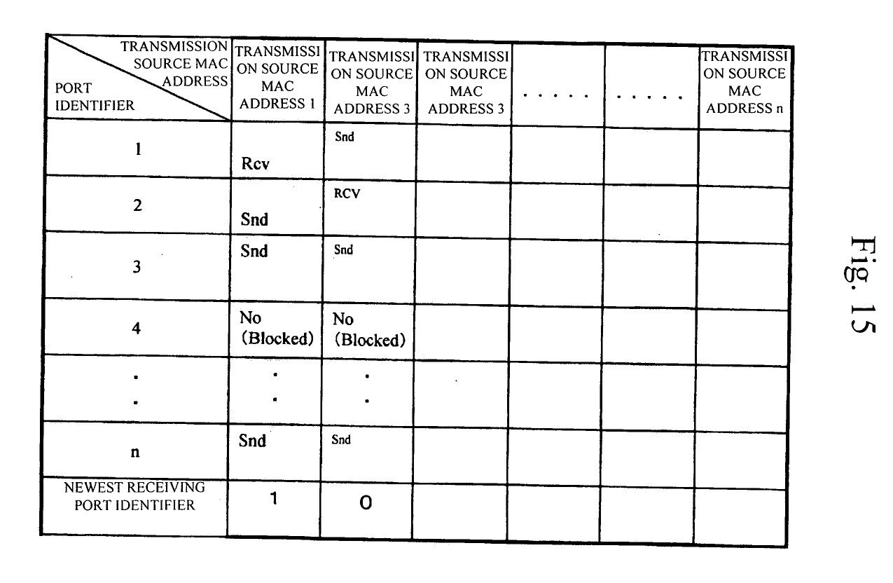

In the figure, device A is referred to as the search starting point device, device F is referred to as the search completion point device, and device B through device E are referred to as the explorer frame relay devices. FIG. 15 shows the format of the search port table 154, which is referred to when forwarding the explorer frame 700.

Specifically, a table (FIG. 15) that controls the status of transmission (Snd)/receiving (RCV)/blocking (No) in the port identifier unit corresponding to the transmission source MAC address stored in the header of the explorer frame 700 is provided in each switching device 100.

In FIG. 6, device A sends by broadcast the loop occurrence location explorer frame 700 to the adjacent connected device F and device B (Steps 1) and 1)*).

By means of Step 1)* (in the figure, the arrow pointing downward), the device F that has received an explorer frame 700 references the search port table 154, and since currently there is only one input/output port that is able to perform communication, performs additional writing of the local switch identifier as the transit node switch position identifier in the received explorer frame 700, and an explorer frame 700 in which 1 has been added to the transit node count is returned to device A. Next, device A receives the explorer frame 700 from device F. Additional writing of the local switch identifier as a transit node switch position identifier in the received explorer frame 700 is performed, and an explorer frame 700 in which 1 has again been added to the transit node count is generated. In this way, the process of specifying a loop is performed.

Additionally, by means of Step 1), since now there are at least two output ports that can be used for communication, the device B which has received the broadcast explorer frame 700 (arrow from left to right in the figure) performs additional writing of the local switch identifier as a transit node switch position identifier in the received explorer frame 700, and the explorer frame 700 to which 1 has been added to the transit node count is forwarded to a port that can perform transmission other than the transmission port corresponding to the receiving port (Step 3)).

When the frame is forwarded, the search table 154 (see FIG. 15) is referenced, and the status of the receiving port identifier corresponding to the transmission source MAC address of the received explorer frame 700 is confirmed. If not all of the receiving port identifiers corresponding to the corresponding transmission source MAC addresses have been received, then currently there will be at least two output ports that can be used for communication, so device B performs the following processes:

(a) It records a received signal (Rcv) in the port identifier column of the received explorer frame 700.

(b) It broadcasts the explorer frame 700 to a usable port other than the transmission port corresponding to the receiving port (Step 3), and records the transmission (Snd) in the port identifier corresponding to the transmission destination thereof in the search table 154.

If some sort of Rcv or Snd has already been recorded in a port identifier corresponding to the transmission source MAC address of the received explorer frame 700,

(a) the explorer frame 700 is sent only to a port identifier in which a received signal (Rcv) has been recorded. However, the transmitted and received signal recording in the search table does not change (see, for example, Steps 7) and 8)).

As stated above, the same process is performed also with respect to device C, device D, and device E as indicated with respect to the processing of the explorer frame 700 (steps 4), 4)*, 5), 5)*, 6), 6)*, and 7)).

Furthermore, device C, device D, and device E similarly perform additional writing of the local switch identifier as a transit node switch identifier in the received explorer frame 700 and forward the explorer frame 700 with the transit node count been incremented by 1 in accordance with the procedure described above.

Device C, device D, and device E also perform processing similar to device B.

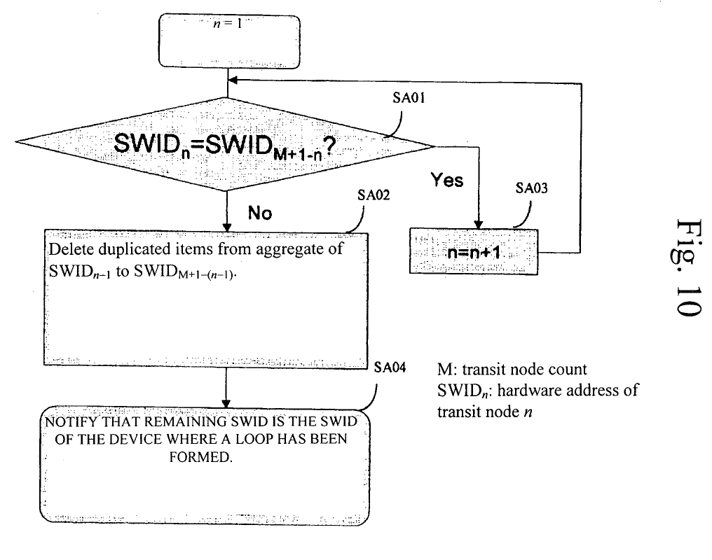

FIG. 10 shows the process flow whereby the loop occurrence location in the network is specified.

First, in a layer-2 network, normally, the communication between two points uses the same route for sending outgoing and return frames. In this example of embodiment, this aspect is to be noticed. Specifically, when explorer packet 700 is sent out and this frame returns, the transit node switch identifier stored in that explorer frame has the same outgoing and return routes between two points, and so has the same bilateral symmetry. However, when a loop is created, it can be seen that bilateral symmetry disappears.

For example, according to FIG. 6, since a loop occurs in the routine of the frames in each of the steps step 4), step 5), and step 6), it can be seen that the transit node switch identifiers recorded in the explorer frame 700 are not bilaterally symmetrical.

In this loop, for example, it is possible to identify the transmission device (node device) in which the loop is formed by means of the flow processing shown in FIG. 10.

In the figure, the final transit node count through which the frame has passed is represented as M, and the switch identifier of the nth node passed through is represented as SWIDn. With regard to each of the transit node switch identifiers n stored in the explorer frame shown in FIG. 9, and with regard to SWIDn, the switch identifier nth from the n=1 switch identifier SWID1, the comparison SWIDn=SWIDM+1-n is performed (Step SA01).

If the results of the comparison match, 1 is added to n (Step SA03), and the process returns to step SA01. If the number in which the results of the aforesaid comparison do not match is made N, then it can be determined that the switching devices having the switching identifiers of SWIDN−1 to SWIDM+1−(N−1) have created a loop.

Removing the redundant elements within the range of SWIDN−1 to SWIDM+1−(N−1) (Step SA02), notification is given that the remaining switch identifiers are switching devices where a loop has been formed (step SA04).

### Embodiment 3

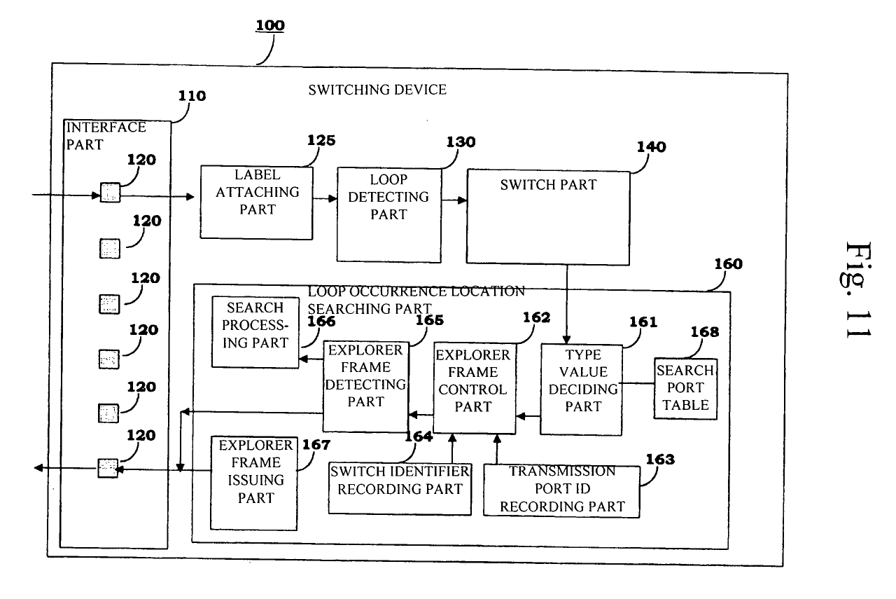

FIG. 11 through FIG. 14 are diagrams showing a third embodiment.

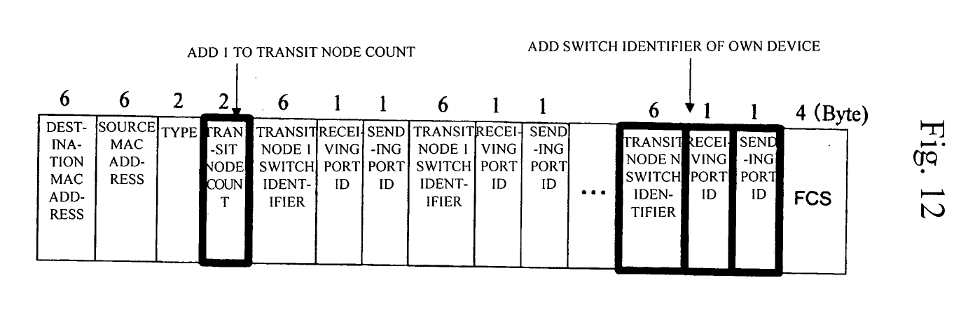

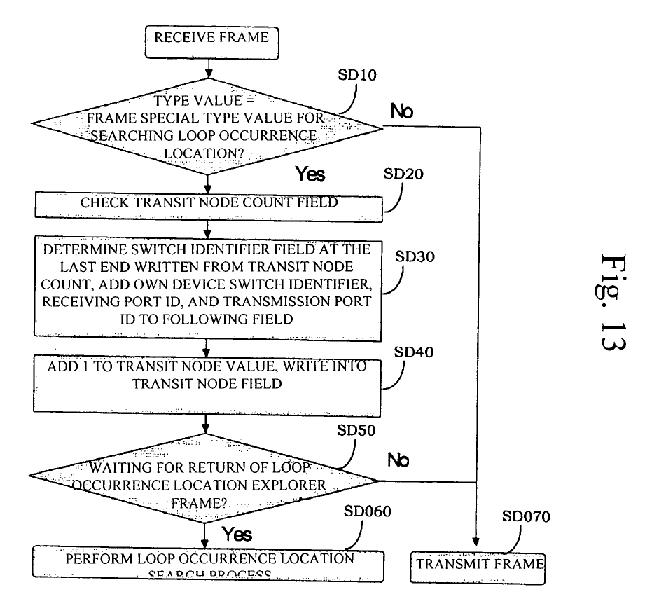

FIG. 11 as a diagram showing an example of embodiment where the loop location of a frame inside a network is searched. This example differs in that a label attaching part 125 and loop occurrence location searching part 160 are newly added to the invention described in FIG. 1. Accordingly, the explanation focuses on this difference. FIG. 12 is one example of an explorer frame. This explorer frame differs in that it records a sending port identifier and receiving port identifier in the aforementioned explorer frame. FIG. 13 is a diagram explaining the process flow when an explorer frame is received.

In this embodiment, by means of the label attaching part 125, a port identifier (identifier of the interface 120) for receiving is attached to the frame input to the switching device 100 via the interface part 110. In addition, based on the transmission source MAC address in receiving port of the input frame, “1” is set as the pertinent newest receiving port identifier (FIG. 15). By investigating this port identifier, more detailed information can be obtained regarding through which physical port of each switching device the frame has passed.

The received frame, as described above, is matched with the frame transmission source MAC address and receiving port identifier by means of the label attaching part 125 and stored in the search port table 168 (FIG. 15).

This frame is forwarded to the type value deciding part 161 of the loop occurrence location searching part 160 via the loop detecting part 130 and switching part 140. The loop detecting part 130 detects loops in frame forwarding in the network and reports such detection to the loop occurrence location searching part 160. The explorer frame issuing part 167 of the loop occurrence location searching part 160 generates the explorer frame to obtain detailed information on the loop. The explorer frame issuing part 167 then generates the explorer frame and forwards the explorer frame to be forwarded by network broadcast via the interface part 110.

After a loop in frame forwarding has been detected, the type value deciding part 161 checks the type value of the input frame and determines whether it is an explorer frame 700 by a method the same as the method described previously (FIG. 13, Step SD10).

If as a result of the aforesaid determination the type value deciding part 161 determines that it is not an explorer frame 700, it routes and forwards this frame through the switch part 140 and interface 110 based on the destination MAC address of the frame (FIG. 13, Step SD70).

If the type value added deciding part 161 determines that this is an explorer frame 700, the frame is forwarded to an explorer frame control part 162.

The explorer frame control part 162 reads the transit node count in the explorer frame 700 (FIG. 12) and checks the transit node count (FIG. 13, Step SD20).

The final writing position in the explorer frame 700 of the local switch identifier is requested. The switch identifier for the local switch device recorded in the switch identifier recording part 164 is read, and the local switch identifier is recorded in a position where it is to be written in the aforesaid explorer frame 700. In addition, the search port table 164 is searched and the most recent receiving port identifier is requested based on the transmission source MAC address of said explorer frame 700, and this receiving port identifier is recorded in a position where it is to be written in the aforesaid explorer frame 700. Further, the transmission reception part identifier recording part 163 specifies the interface 121 selected by the switch part 140 on the basis of the transmission destination MAC address of said explorer frame 700, and records this port identifier in the position where it is to be written in said explorer frame 700 (FIG. 13, Step SD30).

1 is added to the transit node count (FIG. 8, Step S840).

It is determined whether the local switching device 100 is in waiting status for return due to a loop of the loop occurrence location explorer frame (FIG. 13, Step SD50). If it is in waiting status, this is detected by the explorer frame detecting part 165 and forwarded to the search processing part 166. If it is not in waiting status, a frame 700 is transmitted from the interface 120 specified by the switch part 140 (FIG. 13, Step SD70). By adding the local switch identifier of the local switching device 100, the frame length is increased and if the loop occurrence location explorer frame 700 exceeds the MTU (Maximum Transmission Units), it is discarded.

If the loop occurrence location explorer frame 700 has returned due to the occurrence of a loop, based on information recorded in the loop occurrence location explorer frame 700, the search processing part 166 performs a search process for the loop occurrence location (FIG. 13, Step SD60).

The search process for the loop occurrence location is identical to the process already explained and explanation thereof is omitted.

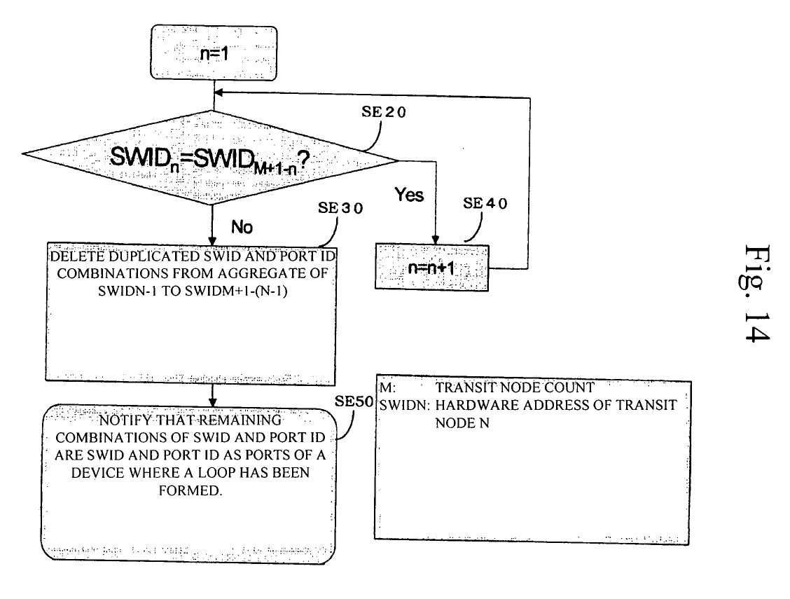

FIG. 14 is a diagram showing the process flow for identifying the loop occurrence location in a network. In this example of embodiment, the fact that the port identifier recorded in the explorer frame 700 is analyzed by the switching device 100 differs greatly from the embodiment described in FIG. 12. Accordingly, the following explanation focuses on the analysis of the port identifier.

In the figure, the final transit node count through which the frame has passed is represented as M, and the switch identifier of the nth node passed through is represented as SWIDn. With regard to each of the transit node switch identifiers n stored in the explorer frame shown in FIG. 9, and with regard to SWIDn, the switch identifier nth from the n=1 switch identifier SWID1, the comparison SWIDn=SWIDM+1−n is performed (Steps SE10 through SE20).

If the results of the comparison match, 1 is added to n (Step SE40), and the process returns to step SE20. If the number where the results of the aforesaid comparison do not match is made N, then it can be determined that the switching devices having the switching identifiers of SWIDN−1 to SWIDM+1−(N−1) have created a loop.

Removing the redundant elements within the range of SWIDN−1 to SWIDM+1−(N−1) (Step SE30), notification is given that the remaining switch identifiers and the corresponding transmission/reception port identifiers represent switching devices where a loop has been formed (step SE50).

In frame forwarding by means of the foregoing process, it is possible to identify the node where a loop has formed.

In the present invention, the configurations described in the following additions can also be considered as configurations:

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1 A switching device comprising:
an interface part operable to input a frame;
a switching part operable to switch in accordance with a destination address of the input frame;
a comparing part operable to compare a switch identifier recorded in the input frame with its own switch identifier; and
a notifying part operable to provide notification of a match when comparison results obtained by the comparing part match.

2 The switching device of claim 1, further comprising:
a deciding part operable to decide whether a switch identifier is recorded in the input frame.

3 The switching device of claim 2, wherein:
the deciding part comprises an unused region reading part operable to examine an error detection code concerning a switch identifier recorded in the input frame, and, if there is no error in the error detection code, to decide that a switch identifier has been recorded in the input frame.

4 The switching device of claim 2, wherein:
the deciding part is further operable to decide whether a switch identifier has been recorded in an unused part in the input frame having a specified protocol.

5 The switching device of claim 2, wherein:
the deciding part comprises an unused region reading part operable to examine an error detection code concerning a switch identifier recorded in the input frame, and, if there is no error in the error detection code, to decide that a switch identifier has been recorded in the input frame.

6 The switching device of claim 1, further comprising:
a loop occurrence location identifying part operable to generate and transmit within a network an explorer frame for detecting the loop occurrence location in the network, based on notification from the notifying part.

7 The switching device of claim 6, wherein:
the loop occurrence location identifying part is further operable to broadcasts the explorer frame into the network.

8 The switching device of claim 7, further comprising:
a search processing part operable to receive the explorer frame and to specify a switching device in which a loop has occurred in the network.

9 The switching device of claim 8, wherein:
the search processing part is further operable to receive the explorer frame, compare identifiers initially and finally recorded with respect to the switch identifier recorded in the explorer frame, so that an interval between a first and last is sequentially narrowed, and to identify a switching device in which a loop has occurred in the network.

10 The switching device of claim 7, further comprising:
a label attaching part operable to collect and record in the explorer frame information with regard to each switch device identifier and port identifier, when a frame is forwarded within the network.

11 The switching device of claim 7, further comprising:
a label attaching part operable to collect and record in the explorer frame information with regard to each switch device identifier, sending port identifier, and receiving port identifier, when a frame is forwarded within the network.

12 The switching device of claim 7, further comprising:
a search port table operable to forward the received explorer frame to a transmission port other than a transmission port corresponding to the receiving port identifier.

13 The switching device of claim 12, further comprising:
an explorer frame controlling part operable to refer to the search port table based on the transmission source address of the explorer frame, and to forward the received explorer frame to a transmission port other than the transmission port corresponding to the receiving port identifier, when an explorer frame from the transmission source address is received first.

14 The switching device of claim 12, further comprising:
an explorer frame controlling part operable refer to the search port table based on the transmission source address of the explorer frame, and to forward the received explorer frame to a transmission port corresponding to the receiving port identifier initially received, when an explorer frame from the transmission source address has already been received.

15 The switching device of claim 12, further comprising:
an explorer frame control part operable to transmit the explorer frame as a frame having a high order of priority.
